(19) United States
(12) Patent Application Publication
(10) Pub. No.: US 2010/0038009 A1
(43) Pub. Date: Feb. 18, 2010

(54) METHOD AND APPARATUS FOR JOINING PROTECTIVE TAPE TO SEMICONDUCTOR WAFER

(76) Inventors: Chouhei Okuno, Osaka (JP); Masayuki Yamamoto, Osaka (JP); Saburo Miyamoto, Mie-ken (JP)

Correspondence Address: Cheng Law Group, PLLC, 1100 17th Street, N.W., Suite 503, Washington, DC, 20036, US

(21) Appl. No.: 12/539,476

(22) Filed: Aug. 11, 2009

(30) Foreign Application Priority Data
Aug. 12, 2008 (JP) 2008-208110

(51) Int. Cl. B32B 38/00; B32B 37/00; B32B 41/00

(52) U.S. Cl. 156/64; 156/60; 156/510; 156/358

(57) ABSTRACT

A protective tape is supplied above the surface of a semiconductor wafer, and joined to the surface of the semiconductor wafer by rolling a joining roller while pressing the joining roller against the protective tape. Then the joined protective tape is cut out along the outer periphery of the semiconductor wafer. Subsequently, the protective tape is pressed with the pressure member to flatten the surface of the protective tape.

### BACKGROUND OF THE INVENTION

1. Field of the Invention

This invention relates to a method and apparatus for joining a protective tape to a semiconductor wafer wherein the protective tape is joined to a surface of the semiconductor wafer having a circuit pattern formed thereon.

2. Description of the Related Art

In order to manufacture chips from a semiconductor wafer (hereinafter, simply referred to as a “wafer”), the following procedures are used.

A circuit pattern is formed on a surface of a wafer, and a protective tape is joined to the surface of the wafer. Then, a grinding process (back grinding) is performed on a rear face of the wafer to thin the wafer. The thinned wafer is joined to and held on a ring frame by a dicing tape. Subsequently, the protective tape on the surface of the wafer is separated from the wafer, and the wafer is transferred to perform a dicing process.

A conventional method of joining a protective tape to a surface of a wafer is implemented as follows.

A band-shaped protective tape having an adhesive face directed downward is supplied above a wafer that is suction-held by a chuck table. A joining roller then rolls on the surface of the protective tape, thereby joining the protective tape to the surface of the wafer. Subsequently, a cutter blade of a tape cutting mechanism pierces the protective tape and moves along an outer periphery of the wafer, allowing the protective tape to be cut along a contour of the wafer. Subsequently, an unnecessary portion of the tape left around the wafer after cutting out along the contour of the wafer is wound and collected. See, for example, JP2005-116711A.

The conventional method, however, has the following problem. The surface of the wafer W with the circuit pattern formed thereon has ridges r, such as bumps, as shown in FIG. 8(a). When the protective tape T is joined to the surface of the wafer W having such a surface state, a base material ta constituting the protective tape T may conform to a shape of an adhesive layer tb, as shown in FIG. 8(b). Specifically, the surface of the protective tape T may be deformed to be uneven corresponding to the ridges r on the surface of the wafer W.

Moreover, the wafer W tends to be further thinned due to high density packaging in recent years. Thus, when grinding the rear face of the wafer W having an irregular surface following the surface of the protective tape T in shape, a problem arises that variations in the amount of grinding may occur on the rear face of the wafer W, leading to a non-uniform thickness of the wafer.

Furthermore, where bubbles are caught on an adhesive interface between the protective tape and the wafer at the time of joining the protective tape, the following problem may occur. Heat is applied to the wafer due to friction created by the back grinding in a subsequent process. Bubbles expand thermally due to the heat. In this state, pressure from the bubbles expanded thermally on the interface acts on the thinned wafer having reduced rigidity, which may fracture the wafer.

### SUMMARY OF THE INVENTION

This invention provides a method and apparatus for joining a protective tape to a semiconductor wafer in which a surface of the joined protective tape is flattened to make a uniform thickness of the back grounded wafer.

Additional features of the invention will be set forth in the description which follows, and in part will be apparent from the description, or may be learned by practice of the invention.

The present invention discloses a method of joining a protective tape to a semiconductor wafer in which the protective tape is joined to a surface of the semiconductor wafer having a circuit pattern formed thereon, comprising the steps of joining the protective tape to the surface of the semiconductor wafer by moving a joining member while pressing the joining member against the protective tape, and pressing the surface of the protective tape joined to the semiconductor wafer with a pressure member.

According to the method for joining the protective tape to the semiconductor wafer, the surface of the protective tape where irregularities are formed due to irregularities on the surface of the wafer when joining the protective tape may be flattened by pressing with the pressure member. Consequently, the rear face of the semiconductor wafer may be grounded such that the semiconductor wafer has a uniform thickness.

The bubbles caught on the adhesive interface between the protective tape and the wafer are finely crushed by pressing with the pressure member, and dispersed in an adhesive layer. Consequently, the expansion coefficient of the bubbles is kept small, even when the wafer is heated due to back grinding, thereby suppressing fractures of the wafer.

The protective tape may be pressed as follows during a tape pressing process.

The entire protective tape may be pressed with a plate-like pressure member having a flat pressure surface.

According to this, method, the entire surface of the protective tape may be rapidly pressed and flattened.

Moreover, the entire protective tape may be pressed with a pressure member having a pressure surface covered with an elastic material.

According to this method, the entire surface of the protective tape may be pressed without applying excessive stress from pressing against the semiconductor wafer. Thus, stress from pressing against the wafer may be reduced, thereby suppressing fractures of the wafer.

Furthermore, the entire surface of the protective tape surface may be pressed with a plate-like pressure member via an adjustable supporting point.

According to this method, the adjustable supporting point allows the pressure member to be moved so as to be inclined freely. In other words, by pressing the pressure plate against the surface of the protective tape, the pressure plate may be moved so as to be inclined in correspondence to the surface of the protective tape. Consequently, even when the surface of the protective tape and the pressure surface of the pressure plate are not completely parallel, the pressure plate may conform entirely to the surface of the protective tape, thereby performing uniform pressing.

In addition, in the above method, the pressure member may act on the protective tape as follows.

For example, a roller-like pressure member may press against the protective tape so as to roll in a direction intersecting with a protective tape joining direction.

Moreover, an edge of the plate-like pressure member may press against the protective tape and slidably or pivotally move while pressing. Furthermore, the pressure member may have a down-curved pressure surface that presses against the entire surface of the protective tape while swinging.

In the above method, the protective tape may be heated during a tape pressing process. The protective tape may he heated indirectly by heating the pressure member or the table for holding the wafer.

According to this method, the base material and adhesive layer of the protective tape may be heated and softened moderately, thereby sufficiently pressing and flattening the surface of the protective tape.

The present invention also discloses a protective tape joining apparatus for joining a protective tape to a semiconductor wafer in which the protective tape is joined to a surface of the semiconductor wafer having a circuit pattern formed thereon. The protective tape joining apparatus includes a holding table to hold the semiconductor wafer, a tape supplying device to supply the protective tape above the surface of the held semiconductor wafer, a joining unit to join the protective tape to the surface of the semiconductor wafer while rolling a joining roller, a tape cutting mechanism to cut the joined protective tape with a cutter blade that moves along an outer periphery of the semiconductor wafer, an unnecessary tape collecting device to remove and collect an unnecessary portion of the protective tape over the outer periphery of the semiconductor wafer, and a tape pressing unit to press the protective tape joined to the surface of the semiconductor wafer with a pressure member.

With this configuration, the above method can be suitably performed.

The tape pressing unit of the apparatus may be a separate and independent unit.

With this configuration, a protective tape joining apparatus capable of deforming the protective tape can easily be realized.

Furthermore, in this configuration, the pressure member of the tape pressing unit may have a pressure plate freely moving vertically to contact and press the entire surface of the joined protective tape.

According to this configuration, the pressure plate may contact and press the entire surface of the protective tape, and thus the entire surface of the protective tape can be rapidly pressed and flattened.

Moreover, in this configuration, the pressure plate can preferably be inclined in all directions through the adjustable supporting point.

According to this configuration, the pressure plate is pressed against the surface of the protective tape, and thus the pressure plate may be inclined to correspond to the surface of the protective tape. Consequently, even when the surface of the protective tape and the pressing surface of the pressure plate are not completely parallel, the pressure plate may conform entirely to the surface of the protective tape, thereby performing uniform pressing.

Moreover, this configuration may include a heater to heat the above pressure member or the holding table.

With this configuration, the base material and adhesive layer of the protective tape may be heated and softened, thereby sufficiently pressing and flattening the surface of the protective tape.

Moreover, this configuration may include a sensor to detect pressure applied to the protective tape by the pressure member, and a control device to control driving of the tape pressing unit based on detection result by the sensor.

With this configuration, the pressure may be adjusted so as to moderately flatten the protective tape T without applying excessive pressure to the wafer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an overall perspective view of a protective tape joining apparatus.

FIG. 2 is a top view of the protective tape joining apparatus.

FIG. 3 is a side view of a tape pressing unit.

FIGS. 4 to 7 are front views each showing a protective tape joining process.

FIGS. 8a to 8e is a schematic view showing processes from a protective tape joining process to a protective tape flattening process.

FIGS. 9 to 11 are side views each showing another exemplary embodiment of the tape pressing unit.

FIGS. 12 to 15 are side views each showing another exemplary embodiment of the tape flattening process.

### DESCRIPTION OF THE PREFERRED EMBODIMENTS

The invention is described more fully hereinafter with reference to the accompanying drawings, in which embodiments of the invention are shown. This invention may, however, he embodied in many different forms and should not be construed as limited to the embodiments set forth herein. Rather, these embodiments arc provided so that this disclosure is thorough, and will fully convey the scope of the invention to those skilled in the art. In the drawings, the size and relative sizes of layers and regions may be exaggerated for clarity. Like reference numerals in the drawings denote like elements.

One exemplary embodiment of this invention will be described in detail hereinafter with reference to the drawings.

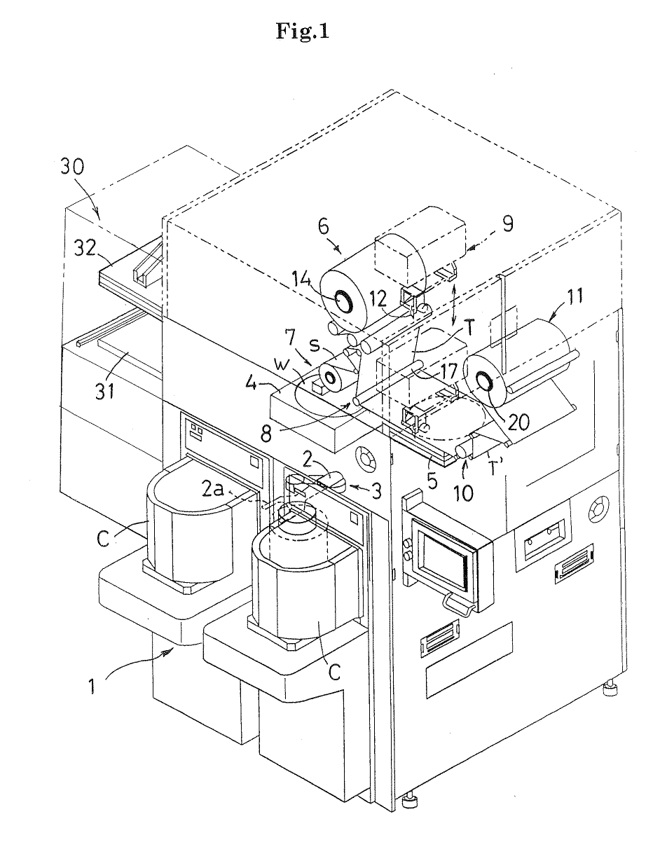

FIG.1 is a perspective view showing a whole configuration of a protective tape joining apparatus.

The protective tape joining apparatus includes a wafer supplying/collecting section 1 with cassettes C placed therein to house a semiconductor wafer W (simply referred to as a “wafer”), a wafer transport mechanism 3 having a robot arm 2, an alignment stage 4, a chuck table 5 to suction-hold the wafer W placed thereon, a tape supplying section 6 to supply a protective tape T provided with a separator s above the wafer W, a separator collecting section 7 to separate the separator s from the protective tape T supplied from the tape supplying section 6 and to collect the separator s, a joining unit 8 to join the protective tape T to the wafer W placed on and suction-held by the chuck table 5, a tape cutting mechanism 9 to cut out the protective tape T joined to the wafer W along a contour of the wafer W, a separation unit 10 to separate an unnecessary tape T′ joined to the wafer W and left out of the wafer W after cutting out the protective tape T, a tape collecting section 11 to wind and collect the unnecessary tape T′ separated with the separation unit 10, and a tape pressing unit 30 to flatten a surface of the protective tape T joined to the wafer W.

Description will be made in detail hereinafter of the configurations of each component and mechanism mentioned above.

The wafer supplying/collecting section 1 has two cassettes C placed in parallel therein. Many wafers W are inserted into and housed in each cassette C horizontally in a stack manner such that each circuit pattern plane (the surface) thereof is directed upward.

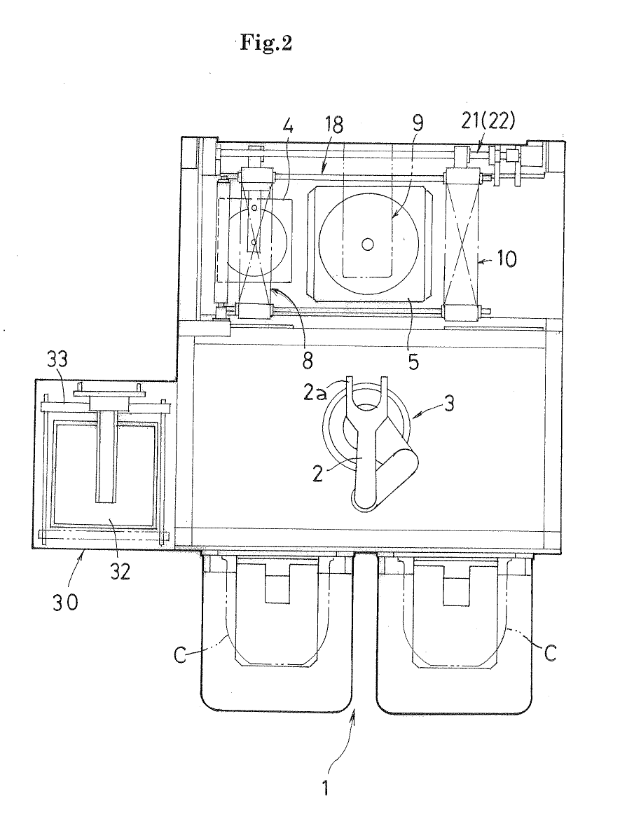

As shown in FIG. 2, the robot arm 2 in the wafer transport mechanism 3 may move forward and backward horizontally. Moreover, the entire robot arm 2 may pivot and move vertically. The robot arm 2 has at the tip end thereof a wafer holder 2a of a vacuum suction type formed in a horseshoe shape. The wafer holder 2a is inserted between the stacked wafers W housed in the cassette C, and suction-holds the wafer W on a rear face thereof. The suction-held wafer W is pulled out from the cassette C, and transported to the alignment stage 4, the chuck table 5, and the wafer supplying/collecting section 1, in turn.

The wafer transport mechanism 3 transports the wafer W to the alignment stage and places the wafer W onto the alignment stage 4. The alignment stage 4 performs alignment of the wafer W based on a notch or an orientation mark formed at an outer periphery of the wafer W.

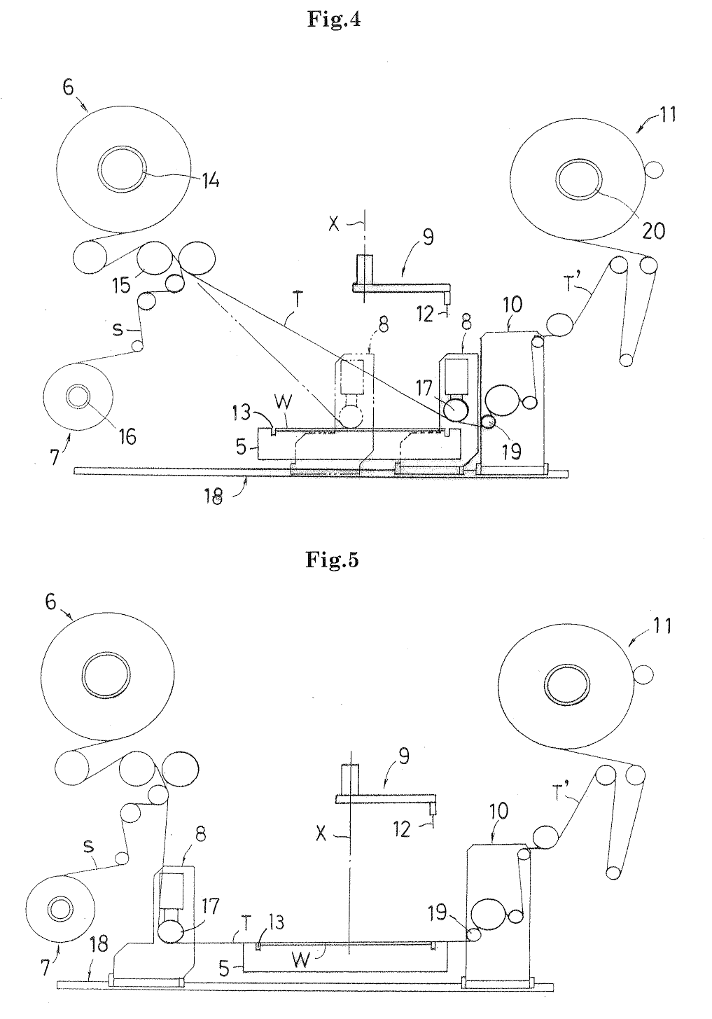

As shown in FIG. 4, the tape supplying section 6 has the following configurations. That is, the tape supplying section 6 winds and guides the protective tape T provided with the separator s fed out from a supply bobbin 14 to a guide roller group 15. The protective tape T with the separator s separated therefrom is guided to the joining unit 8. In addition, appropriate rotational resistance is applied to the supply bobbin 14 in order to prevent the protective tape T from being fed out excessively.

The separator collecting section 7 has a configuration in which a collecting bobbin 16 to wind the separator s separated from the protective tape T rotates in a winding direction.

The joining unit 8 includes a joining roller 17 disposed horizontally in a forward directed position and the joining roller 17 reciprocates horizontally in a plane as shown in FIG. 2, with a slide-guide mechanism 18 and a screw-feed type drive mechanism.

The separating unit 10 has a separation roller 19 disposed horizontally in a forward directed position, and the separation roller 19 reciprocates horizontally in a plane as shown in FIG. 2, with the slide-guide mechanism 18 and the screw-feed type drive mechanism.

The tape collecting section 11 has a configuration in which a collecting bobbin 20 to wind the unnecessary tape T′ rotates in a winding direction.

The tape cutting mechanism 9 has a configuration in which a cutter blade 12 having a tip end thereof directed downward may move vertically and pivotally about a vertical axis X passing the center of the chuck table 5.

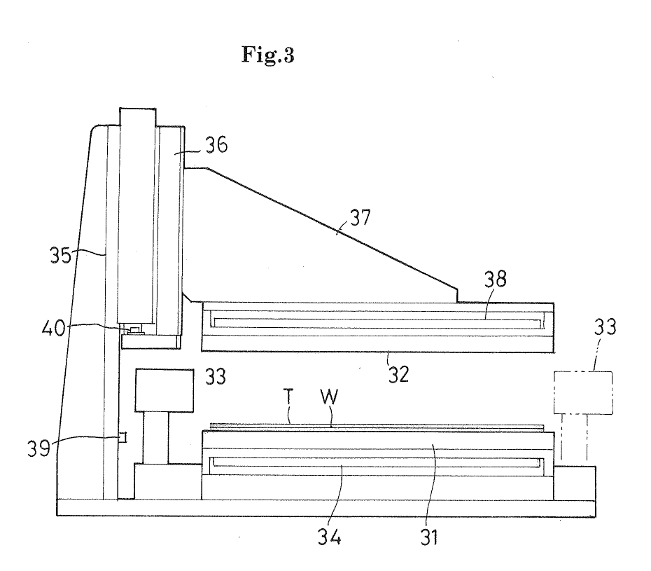

As shown in FIG. 1, the tape pressing unit 30 is arranged on the lateral outside of the wafer transport mechanism 3 (on the left side of FIG. 1). As shown in FIG. 3, the tape pressing unit 30 includes a holding table 31 to horizontally place and vacuum-suction the wafer W subjected to the protective tape joining process in a position where the protective tape T is directed upward, a pressure plate 32 arranged as a pressure member to press against the protective tape T on the wafer W placed on the holding table 31, and a line sensor 33 using a laser sensor to determine the degree of flatness of the surface of the protective tape T by scanning horizontally in forward and backward directions (in right and left directions in a plane as shown in FIG. 3). Here, the tape pressing unit 30 is a separate unit.

The holding table 31 incorporates a heater 34. The heater 34 moderately heats the wafer W placed on the holding table 31 and the protective tape T on the surface of the wafer W.

The pressure plate 32 is coupled to and supported by a movable table 36 via a support arm 37. The movable table 36 controls vertical movement along a vertical frame 35 in a screw-feeding manner. The underside of the pressure plate 32 has a size that covers the surface of the wafer W, and is formed as a flat pressure surface. A parallel relationship of the pressure surface of the pressure plate 32 and the surface of the holding table 31 may be secured with higher accuracy. Moreover, the pressure plate 32 incorporates a heater 38.

Next, with reference to FIGS. 4 to 7, description will be made of a series of operations for joining the protective tape T to the surface of the wafer W and then cutting the protective tape T using the above-mentioned apparatus according to one exemplary embodiment of this invention.

A joining command is issued, and then the robot arm 2 in the wafer transport mechanism 3 moves towards the cassette C placed on a cassette table. The wafer holder 2a is inserted between the wafers housed in the cassette C. Subsequently, the wafer holder 2a suction-holds the wafer W on the rear face (the underside) thereof, and pulls out the wafer W, and moves to place the wafer W on the alignment stage 4.

The alignment stage 4 performs alignment of the wafer W placed thereon, through use of a notch formed at the outer periphery of the wafer W. The robot arm 2 then transfers the aligned wafer W from the alignment stage 4 to the chuck table 5, and places the wafer W on the chuck table 5.

The wafer W placed on the chuck table 5 is suction-held so as to be aligned with the chuck table 5. As shown in FIG. 4, herein, the joining unit 8 and separation unit 10 are in a standby position on the right side of FIG. 4. Moreover, the cutter blade 12 of the tape cutting mechanism 9 is in a standby position on the upper side of FIG. 4.

Next, as shown in FIG. 4, the joining roller 17 of the joining unit 8 moves downward, and presses the protective tape T downward while rolling on the wafer W in the forward direction (in the left direction of FIG. 4). Thus, the protective tape may be joined to the entire surface of the wafer W and the portion out of the wafer on the chuck table 5.

As shown in FIG. 5, when the joining unit 8 reaches a terminal position, the cutter blade 12 on the upper side moves downward, and pierces a portion of the protective-tape T on the cutter blade traveling groove 13 of the chuck table 5.

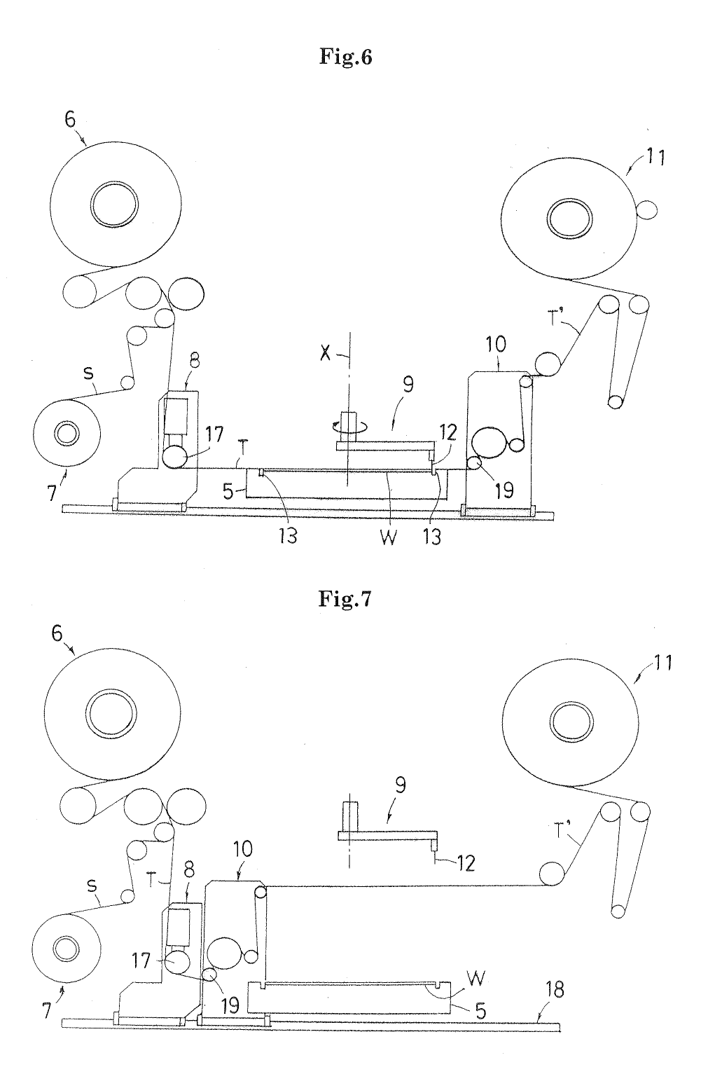

Next, as shown in FIG. 6, the cutter blade 12 turns in sliding contact with the outer peripheral edge of the wafer W, thereby cutting the protective tape T along the outer periphery of the wafer W.

When cutting of the protective tape T along the outer periphery of the wafer W is completed, the cutter blade 12 moves to the original standby position, as shown in FIG. 7. The separating unit 10 then moves forward while lifting up and separating the unnecessary tape T′ joined around the wafer W on the chuck table 5 after cutting out on the wafer W.

When the separating unit 10 reaches a position where separating is completed, the separation unit 10 and joining unit 8 move backward and return to the standby position. Here, the collecting bobbin 20 winds up the unnecessary tape T′, and the tape supplying section 6 feeds out a given amount of the protective tape T.

When the above tape joining operation is completed, the chuck table 5 releases the suction-holding of the wafer W. Subsequently, the wafer holder 2a of the robot arm 2 transfers the wafer W subjected to the joining process from the chuck table 5 to the tape pressing unit 30.

The wafer W supplied to the tape pressing unit 30 is placed and suction-held on the holding table 31 with the protective tape T joined to the surface of the wafer W that is directed upward.

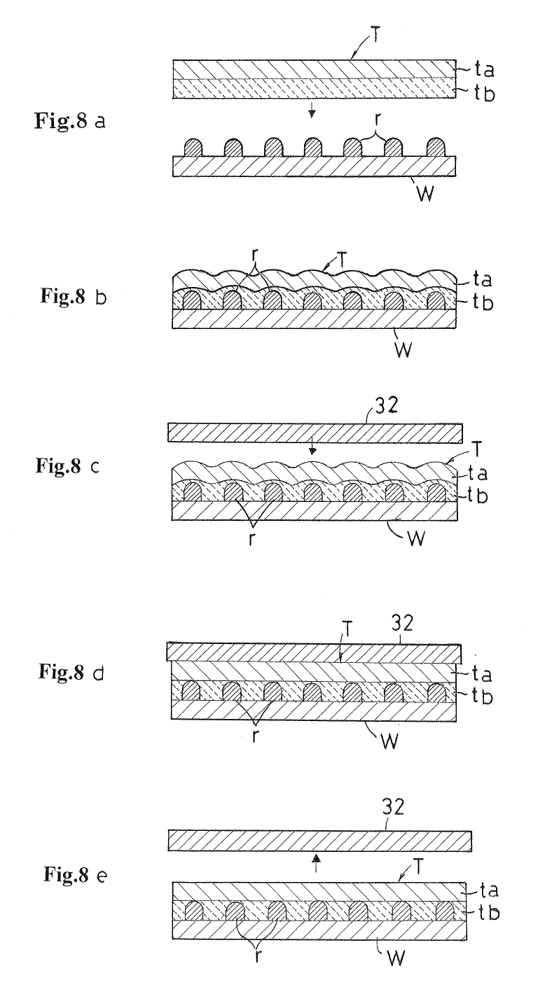

Next, as shown in FIG. 3, the movable table 36 that is retracted upward moves downward, and the pressure plate 32 presses against the upper surface of the protective tape T by a predetermined pressure. The limit sensor 40 detects when the movable table 36 moves downward to a predetermined position to approach a stationary detection piece 39, and then the movable table 36 stops moving downward. Thus, pressing may be maintained while heating for a predetermined time. A height at which downward movement of the pressure plate 32 stops is set in advance to correspond to thicknesses of the wafer W, protective tape, and adhesive layer tb. As shown in FIG. 8(d), the base material ta of the protective tape T is pressed until it approaches the ridges r on the wafer, thereby deforming the base material ta made of resin to make the surface of the protective tape T flat.

When performing pressing and flattening processes, the heater 38 heats the pressure plate 32 and the heater 34 heats the holding table 31 to temperatures corresponding to the type and thickness of the protective tape T.

After the pressing and flattening processes, the pressure plate 32 moves upward and retracts as shown in FIG. 8(e). Subsequently, the line sensor 3.3 scans the surface of the protective tape T to determine the degree of flatness on the surface thereof. When the determined degree of flatness falls within a tolerance determined in advance, the robot arm 2 feeds out the wafer W, and inserts the wafer W into the cassette C in the wafer supplying/collecting section 1.

When the determined degree of flatness is outside of the tolerance, another flattening process is performed for the protective tape, or the protective tape is transported as defective.

Thus, one tape joining process is completed as described above. Thereafter, the foregoing operations are performed on each new wafer in succession.

The protective tape T may be attached firmly to the pressure plate 32 due to pressing by the pressure plate 32. In order to avoid this, a releasing treatment is performed on the pressure surface of the pressure plate 32, or the pressure plate 32 is made of a porous material through which air can be vented. That is, when the pressure plate 32 is made of a porous material and is moved toward the retract position, the protective tape T may be easily separated from the pressure plate 32 through vented air from the pressure surface of the pressure surface 32.

As mentioned above, after joining the protective tape T to the surface of the wafer W, the pressure plate 32 presses against the protective tape T to flatten the protective tape T, thereby realizing a wafer of uniform thickness. Consequently, the wafer W may be grounded uniformly when back grinding in the subsequent process.

The bubbles caught on the adhesive interface between the protective tape T and the wafer W during joining the protective tape T are pressed and finely crushed, and then dispersed in the adhesive layer tb. Consequently, the expansion coefficient of bubbles is small, even when the wafer W is heated through back grinding in the subsequent process, thereby suppressing fractures of the wafer W.

In exemplary embodiments of this invention, the tape pressing unit may be implemented in the following forms.

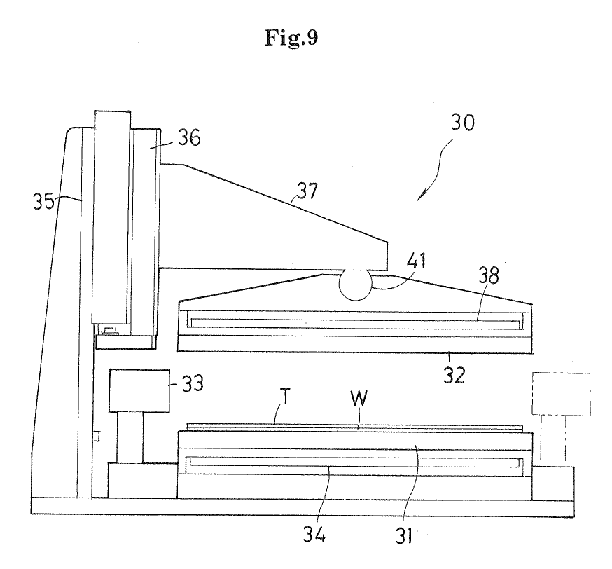

As shown in FIG. 9, the tape pressing unit may have a configuration in which the pressure plate 32 is coupled to the support arm 37 via the adjustable supporting point 41 so as to be inclined freely in every direction within a small predetermined range. With this configuration, the underside of the pressure plate 32 may follow the inclination of the surface of the protective tape T, thereby performing uniform pressing.

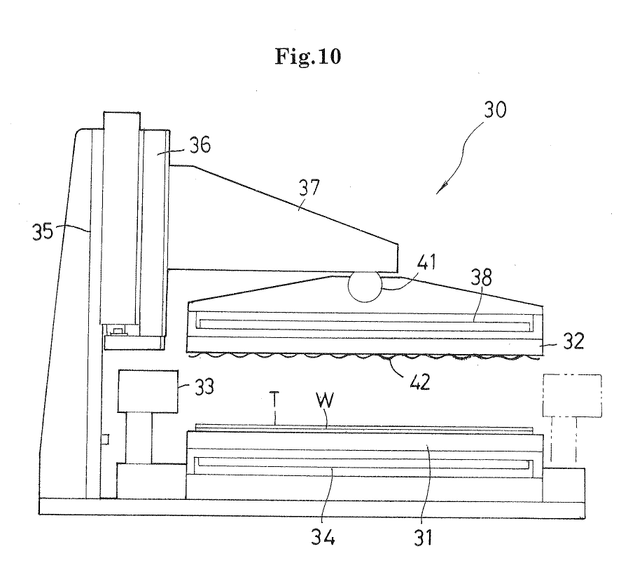

As shown in FIG. 10, the tape pressing unit may also have a configuration in which plate springs 42 with irregularities may be formed on the entire pressure surface of the pressure plate 32 as an elastic material deformable with relatively small external forces. For instance, the plate springs, each having a small diameter of around several millimeters, are arranged on the pressure surface of the pressure plate 32 in a two-dimensional array. With this configuration, the plate springs 42 may be elastically deformed to be flat by being pressed against the protective-tape T.

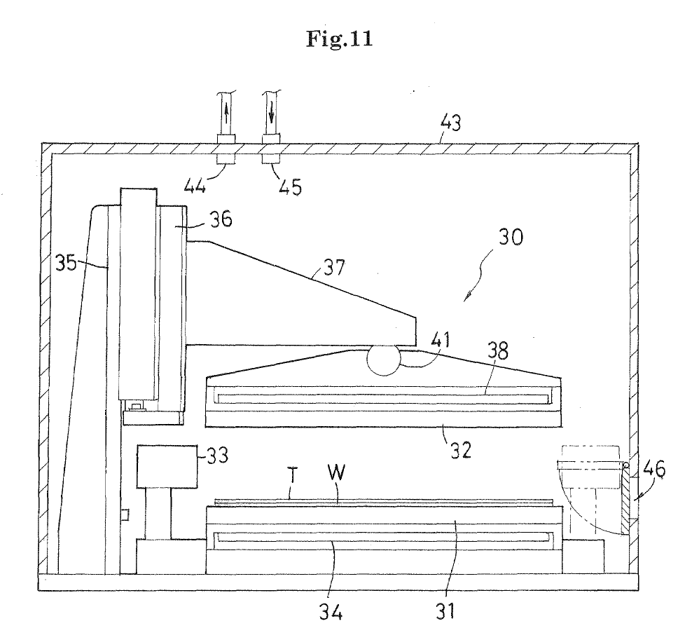

As shown in FIG. 11, the tape pressing unit may be surrounded with a vacuum chamber 43 to perform pressing and flattening processes in a vacuum atmosphere. With this configuration, air caught between the wafer W and the protective tape T or bubbles included in the adhesive layer tb of the protective tape T can be eliminated, thereby facilitating flattening of the surface of the protective tape T. Here, FIG. 11 includes an exhaust opening 44, an air input 45, and a wafer entrance 46 that may he opened and closed.

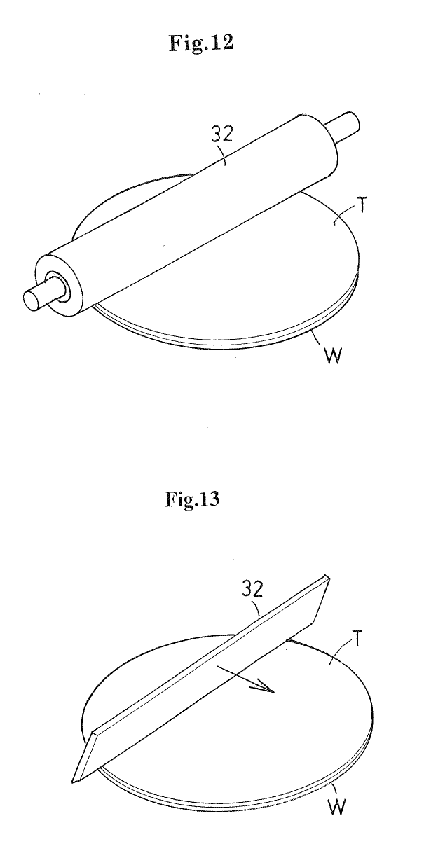

As shown in FIG. 12, the pressure roller 32 that rolls on the protective tape T may be used as a pressure member to perform pressing and flattening processes. Here, the pressure roller may contain a heater, if needed.

In this case, the pressure roller rolls in a direction that intersects with a direction of joining the protective tape T.

With this configuration, the base material ta of the protective tape T can be extended in all directions, thereby realizing a more uniform flat surface.

As shown in FIG. 13, a pressing blade 32 that moves in sliding contact with the protective tape T may also be used as the pressure member for pressing and flattening processes. Here, the pressure blade may move in sliding contact with the protective tape T in a direction that intersects with a direction of joining the protective tape T.

With this configuration, the base material ta of the protective tape T can be extended in all directions, thereby realizing a more uniform flat surface.

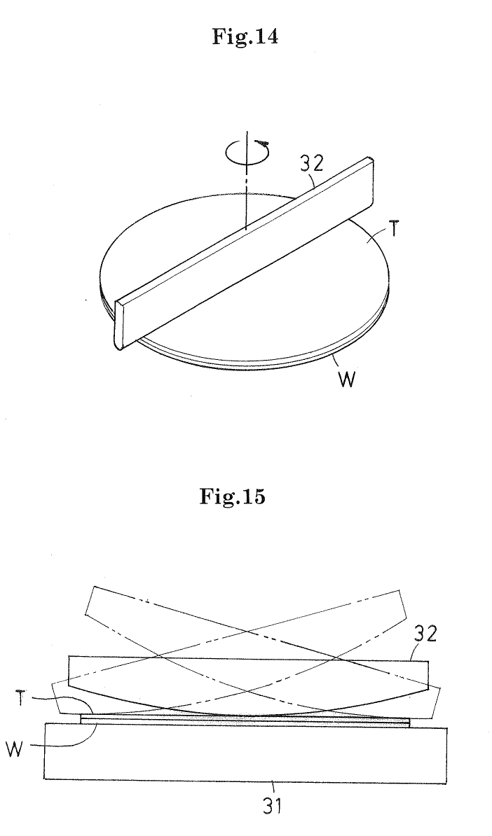

As shown in FIG. 14, the pressure member may include a pressure blade 32 for use in pressurizing and flattening processes, which moves in sliding contact with the protective tape T while pivoting.

As shown in FIG. 15, the pressure member, 32 may press against the protective tape T while swinging. The pressure member 32 with the down-curved surface has a contact area whose longitudinal width is greater than a diameter of the wafer W.

In the exemplary embodiment described above, the tape pressing unit 30 is a separate unit and is attached to the main components of the tape joining apparatus. The tape pressing unit 30 may also be incorporated into the main components of the tape joining apparatus. Specifically, the tape pressing unit 30 may be constituted to perform pressing and flattening processes while being held on the chuck table 5.

In the exemplary embodiment described above, a load cell may be placed on the pressure surface of pressure member 32. The load cell detects a pressure by the pressure member 32 in succession, and feeds back the detection result to a controller, thereby controlling pressure applied to the protective tape T.

With this configuration, appropriate pressure can be applied to the protective tape T, thereby suppressing fractures of the wafer W. Here, the load cell corresponds to the sensor arranged to detect the pressure applied to the protective tape T in the tape pressing process of this invention.

With this configuration, the pressure to the wafer W can be controlled to flatten the protective tape T moderately without applying excessive pressure to the wafer W.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of joining a protective tape to a semiconductor wafer in which the protective tape is joined to a surface of the semiconductor wafer having a circuit pattern formed thereon, comprising:
joining the protective tape to the surface of the semiconductor wafer by moving a joining member while pressing the joining member against the protective tape; and
pressing the surface of the protective tape joined to the semiconductor wafer with a pressure member.

2. The method of joining the protective tape to the semiconductor wafer according to claim 1, wherein
pressing the surface of the protective tape comprises pressing an entire surface of the protective tape with a plate-like pressure member having a flat pressure surface.

3. The method of joining the protective tape to the semiconductor wafer according to claim 2, wherein
pressing the surface of the protective tape comprises pressing the entire surface of the protective tape with a pressure member having a pressure surface covered with an elastic material.

4. The method of joining the protective tape to the semiconductor wafer according to claim 2, wherein
pressing the surface of the protective tape comprises pressing the entire surface of the protective tape surface with the plate-like pressure member via an adjustable supporting point.

5. The method of joining the protective tape to the semiconductor wafer according to claim 1, wherein
pressing the surface of the protective tape comprises pressing the protective tape with a roller-like pressure member while rolling the roller-like pressure member.

6. The method of joining the protective tape to the semiconductor wafer according to claim 1, wherein
pressing the surface of the protective tape comprises pressing the protective tape with the roller-like pressure member while rolling the roller-like pressure member in a direction that intersects with a protective tape joining direction.

7. The method of joining the protective tape to the semiconductor wafer according to claim 1, wherein
pressing the surface of the protective tape comprises pressing the protective tape with an edge of the plate-like pressure member while moving the edge of the plate-like pressure member in sliding contact with the protective tape.

8. The method of joining the protective tape to the semiconductor wafer according to claim 1, wherein
pressing the surface of the protective tape comprises pressing the protective tape with the edge of the plate-like pressure member so as to pivot the edge of the plate-like pressure member around a center of the semiconductor wafer while pressing.

9. The method of joining the protective tape to the semiconductor wafer according to claim 1, wherein
pressing the surface of the protective tape comprises pressing the entire surface of the protective tape while swinging a pressure member having a down-curved pressure surface.

10. The method of joining the protective tape to the semiconductor wafer according to claim 1, wherein
pressing the surface of the protective tape comprises heating the protective tape.

11. The method of joining the protective tape to the semiconductor wafer according to claim 10, wherein
the protective tape is heated by heating the pressure member with a heater.

12. The method of joining the protective tape to the semiconductor wafer according to claim 10, wherein
the protective tape is heated by heating a table arranged to hold the semiconductor wafer placed thereon with a heater.

13. The method of joining the protective tape to the semiconductor wafer according to claim 1, wherein
pressing the surface of the protective tape comprises detecting pressure applied to the protective tape by the pressure member with a sensor, and controlling the pressure based on detection result by the sensor.

14. A protective tape joining apparatus for joining a protective tape to a semiconductor wafer in which the protective tape is joined to a surface of the semiconductor wafer having a circuit pattern formed thereon, comprising:
a holding table to hold the semiconductor wafer;
a tape supplying device to supply the protective tape above the surface of the held semiconductor wafer;
a joining unit to join the protective tape to the surface of the semiconductor wafer while rolling a joining roller;
a tape cutting mechanism to cut the joined protective tape with a cutter blade that moves along an outer periphery of the semiconductor wafer;
an unnecessary tape collecting device to remove and collect an unnecessary portion of the protective tape over the outer periphery of the semiconductor wafer; and
a tape pressing unit to press the protective tape joined to the surface of the semiconductor wafer with a pressure member.

15. The protective tape joining apparatus according to claim 14, wherein
the tape pressing unit is a separate and independent unit.

16. The protective tape joining apparatus according to claim 14, wherein
the pressure member of the tape pressing unit has a pressure plate freely moving vertically that contacts and presses an entire surface of the joined protective tape.

17. The protective tape joining apparatus according to claim 14, wherein
the pressure plate is inclined in all directions through an adjustable supporting point.

18. The protective tape joining apparatus according to claim 14, wherein
the pressure plate comprises a heater.

19. The protective tape joining apparatus according to claim 14, wherein
the holding table comprises a heater.

20. The protective tape joining apparatus according to claim 14, further comprising:
a sensor to detect pressure applied to the protective tape by the pressure member; and
a control device to control driving of the tape pressing unit based on detection result by the sensor.
